(19) United States
(12) Patent Application Publication
(10) Pub. No.: US 2006/0150402 A1
(43) Pub. Date: Jul. 13, 2006

(54) Center position device of piston rod of riveter

(76) Inventor: Yu-Ching Lin, Sijhih City (TW)

Correspondence Address: TROXELL LAW OFFICE PLLC, Suite 1404, 5205 Leesburg Pike, Falls Church, VA, 22041, US

(21) Appl. No.: 11/033,179

(22) Filed: Jan. 12, 2005

(51) Int. Cl. B23P 11/00

(52) U.S. Cl. 29/812.5; 29/243.53

(57) ABSTRACT

A center position device of a piston rod of a riveter primarily comprises a position device screwed on a threaded hole below a handle, wherein the position device comprises a pillar hole for being penetrated by a piston rod and a sealing ring fitted closely with the piston rod. A position ring, a ring trench, and a sealing ring are mounted to align the same centerline. At least two ring surfaces forms on an opening of the threaded hole of the handle to which the position device is screwed. When the position device is screwed to the threaded hole, the position ring of the position device touches closely with a ring surface. When the position device is screwed and fixed to the threaded hole of the handle, the centerline of the position will not suffer from deviation to prevent the accuracy of displacement of the piston rod from being affected.

### BACKGROUND OF THE INVENTION

1. Field of the Invention

The present invention relates to a riveter, and more particularly to a center position device of a piston rod of the riveter.

2. Description of the Related Art

In the conventional riveter, a riveting component is mounted above a handle, wherein a pillar hole is formed on the center of the handle. A screw nut having a central pillar hole is screwed to the opening of the pillar hole. A pressure tank is screwed on the outer ring surface of the lower opening of the handle. A piston is assembled to the inner tank surface of the pressure tank. A piston rod is stretched from the pillar hole of the screw nut mounted below the handle to the position of an oil chamber. By use of compressed air, the piston rod is shifted to guide the piston rod that stretches into the position of the oil chamber to push the oil liquid for performing the riveting operation. The screw nut that screws on the opening of the central pillar hole of the handle comprises the pillar hole, which is penetrated by the piston rod. When the screw nut is screwed and fixed to the pillar hole of the handle, it is always affected by the screw gap that causes the piston rod to generate deviation and affects the push force of the piston and the normal motion of the operation of the riveting component.

### SUMMARY OF THE INVENTION

The main object of the present invention is to provide a riveter that comprises a threaded hole and several position ring surfaces on an opening of a central pillar hole of a handle of the riveter. A position device is screwed to the opening of the central pillar hole of the handle. An outer thread, a ring trench, a sealing ring, and a position ring are mounted on its outer ring surface. The position device is screwed to the threaded hole of the handle. Next, the position ring of the position device is closely touched and connected with the ring surface that forms on the outer end of the threaded hole of the handle for guiding and combination. Consequently, the centerline of the position will not suffer from deviation thereby preventing the displacement accuracy of the center of the piston rod from being affected.

In accordance with another object of the present invention, the ring trench and the sealing ring are mounted on the outer ring surface of the position device to match up the diameter dimension of the outer ring surface of the pillar hole of the piston rod. When the position device screws and fixes to the threaded hole that forms on the end of the handle, the sealing ring touches the ring surface closely to provide the anti-leakage function for this assemblage interface.

In accordance with still another object of the present invention, several ring trenches and sealing rings are disposed on the surface of the central pillar hole of the position device for touching the piston rod closely and providing the anti-leakage function.

The other features and preferred embodiments of the present invention will now be described with reference to the accompanying drawings.

### BRIEF DESCRIPTION OF THE DRAWINGS

FIG. 1 is an elevational view of the present invention.

FIG. 2 is a cross-section view of the present invention.

FIG. 3 is a cross-section view showing a center position device of a piston rod of the present invention.

FIG. 4 is a cross-section view showing the screwing and position status of the position device of the present invention.

### DETAILED DESCRIPTION OF THE PREFERRED EMBODIMENT

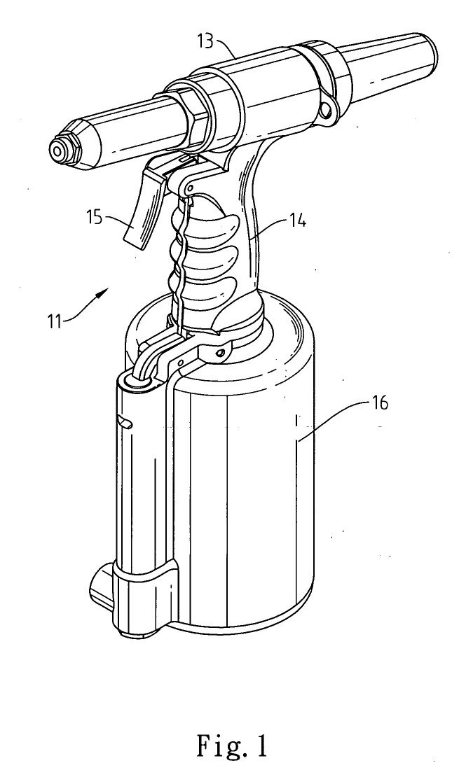

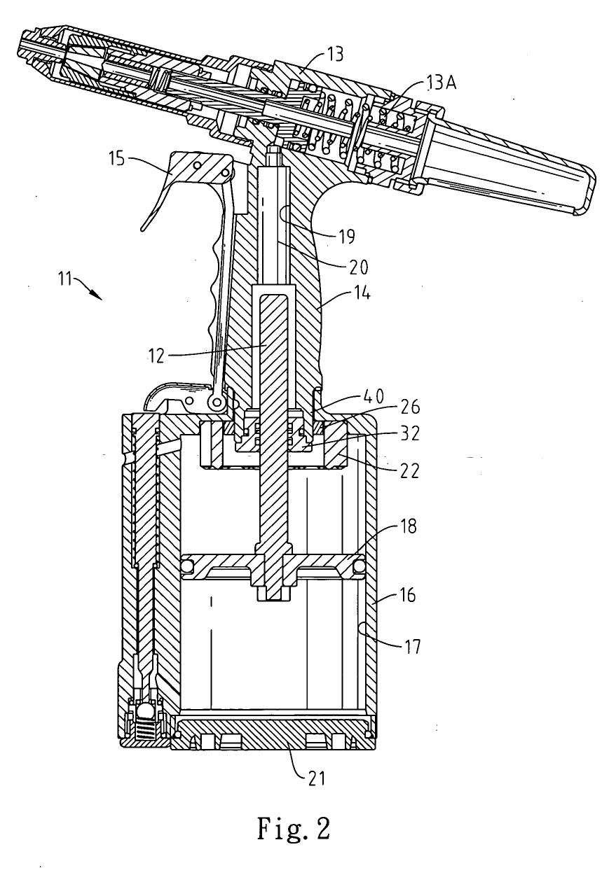

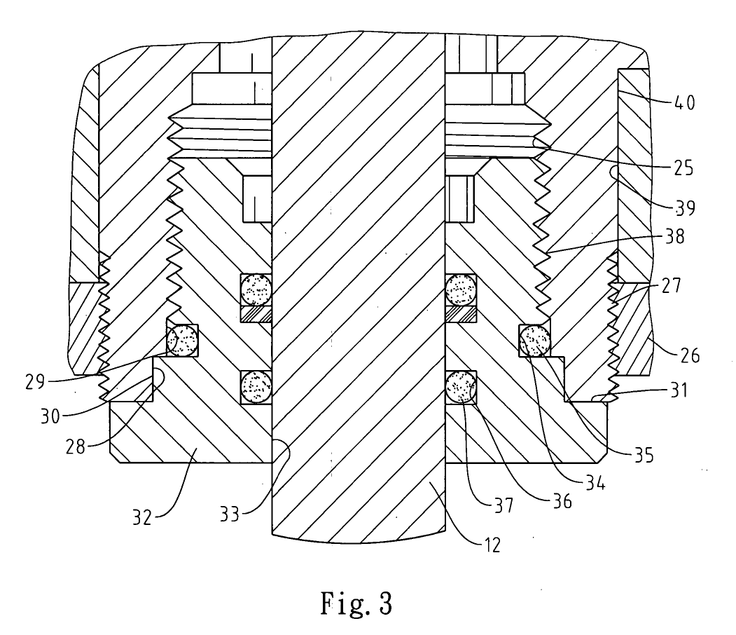

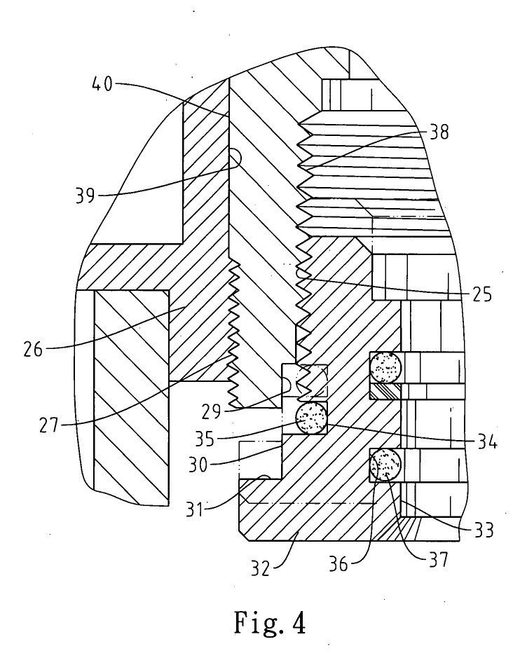

As shown in FIG. 1 through FIG. 4, the present invention relates to a center position device of a piston rod of a riveter. The riveter 11 comprises a handle 14, a main body 13, and a riveting component, wherein the main body 13 and the riveting component are mounted above the handle 14. A trigger 15 is mounted on the front end of the handle 14 for controlling the compressed air. A pressure tank 16 is mounted below the handle 14. The trigger 15 controls the compressed air to pass into the pressure tank 16, wherein the compressed air pushes upward the piston 18 that mounts inside the pressure tank 16 to shift the oil liquid that stores in a central oil chamber 20 of the handle 14 toward the riveting component for performing the riveting operation.

A circular pillar surface 40 of the handle 14 is inserted into a pillar hole 39 of the upper ring portion of the pressure tank 16 that mounts below the handle 14. Next, the pressure tank 16 is screwed and fixed to the circular pillar surface 40 that forms on the lower end of the handle 14 by use of a threaded ring 26. The inner tank surface and the pillar hole 39 of the upper ring portion of the pressure tank 16 are pre-treated by lathe, and then ground in a homocentric manner, wherein the centers of the inner tank surface and the pillar hole 39 align the same centerline.

The handle 14 of the riveter 11 comprises a pillar hole 19 mounted on its center, wherein a threaded hole 25 and a ring surface 28 are formed respectively on the outer end of the pillar hole 19, and the circular pillar surface 40 and an outer thread 27 are formed on the outer ring surface of the handle 14. The threaded hole 25 and the ring surface 28 mounted on the center of the handle 14 and the circular pillar surface 40 and the outer thread 27 mounted on the outer ring surface of the handle 14 are accomplished by lathe simultaneously. Thereafter, the ring surface 28 and the circular pillar surface 40 are ground in a homocentric manner, wherein the centers of these two ring surfaces align the same centerline.

The circular pillar surface 40 mounted on the lower end of the handle 14 is inserted into the pillar hole 39 that forms on the upper ring portion of the pressure tank 16. Next, the pressure tank 16 is screwed and fixed below the handle 14 by the threaded ring 26. The assemblage surface between these two components is designed precisely so that the center of the inner tank surface of the assembled pressure tank 16 and the center of the ring surface 28 and the threaded hole 25, which form on the center of the handle 14, are posited to align the same centerline.

The piston 18 that mounts on the inner tank surface of the pressure tank 16 includes a piston rod 12 mounted on its center, wherein one end of the piston rod 12 is stretched from the central pillar hole 33 of a position device 32 that screws to the end portion of the threaded hole 25 of the handle 14 to the oil chamber 20 that mounts on the inside of the handle 14. The position device 32 where the piston rod 12 penetrates through includes a penetrating pillar hole 33 formed on its center. The pillar hole 33 has a diameter dimension equal to or slightly larger than that of the piston rod 12. Several ring trenches 36 and sealing rings 37 mounted therein are disposed on the inner ring surface of the pillar hole 33 so as to enable the piston rod 12 to penetrate through the pillar hole 33 of the position device 32 and touch the sealing rings 37 mounted on the ring trenches 36, wherein the assemblage interfaces will not suffer from oil leakage during the operation of the piston rod 12.

The position device 32 is pre-screwed into the threaded hole 25 that forms on the opening of the central pillar hole 19 of the handle 14. The position device 32 includes the pillar hole 33 on its center. The position device 32 also includes an outer thread 38, a ring trench 34, a position ring 30, and an outer ring plate 31 mounted on its outer ring surface, wherein the outer thread 38 is disposed to cooperate with the threaded hole 25 of the handle 14, and a sealing ring 35 is disposed in the ring trench 34. The sealing ring 35 and the position ring 30 that mounts on its outer end are disposed to cooperate with the ring surfaces 28 and 29 of the handle 14. The outer ring plate 31 having a larger diameter dimension is disposed on its outer end. The central pillar hole 33 of the position device 32 and the outer thread 38, the ring trench 34, and the position ring 30 mounted on the outer ring surface of the position device 32 are first accomplished by lathe simultaneously. Thereafter, the central pillar hole 33 and the position ring 30 are ground in a homocentric manner, wherein the centers of these two align the same centerline.

Before assembling the pressure tank 16 to the piston 18, the position device 32 is screwed and fixed to the threaded hole 25 that forms on the outer end of the pillar hole 19 of the handle 14. The handle 14 includes the ring surfaces 29 and 28 with larger diameter dimensions on the outer edge of the threaded hole 25, which is formed on the outer end of the pillar hole 19. When the position device 32 is screwed to the threaded hole 25, the outer thread 38 of the position device 32 is applied to the screwing operation until the position ring 30 of the position device 32 touches and inserts into the ring surface 28 that forms on the outer end of the threaded hole 25 such that these two components are assembled and integrated into a unity.

Since the position ring 30 of the position device 32 and the ring surface 28 formed on the outer end of the threaded hole 25 of the handle 14 are ground in the homocentric manner. The outer thread 38 of the position device 32 is screwed into the threaded hole 25 that forms on the end portion of the pillar hole 19 of the handle 14. Thereafter, the ground position ring 30 is inserted into the ring surface 28 that forms on the outer end of the threaded hole 25. Accordingly, the sealing ring 35 that mounts on the ring trench 34 provides the function of anti-leakage for this assemblage interface between the handle 14 and the position device 32. The position device 32 is screwed and fixed to the threaded hole 25 that forms on the opening of the pillar hole 19 of the handle 14. By use of the ring surface 28 and the position ring 30, which are ground in the homocentric manner, the centerline of the central pillar hole 33 of the position device 32 is able to align nearly with the centerline of the pressure tank 16, which screws to the outer end of the piston rod 12.

The central pillar hole 33 of the position device 32 includes the ring trenches 36 and the sealing rings 37 mounted therein, wherein the position device 32 is mounted below the handle 14. When the piston 18 is mounted on the tank surface of the pressure tank 16, the piston rod 12 that mounts on the center of the piston 18 is stretched from the center hole of the position device 32 to the pillar hole 19 of the piston rod 12. The sealing ring 37 that mounts on the ring trench 34 provides the function of anti-leakage between the pillar hole 19 and the pressure tank 16.

The piston 18 is fitted onto the location of the pressure tank 16. The components mounted on the lower portion of the pressure tank 16 are screwed and fixed together. The oil liquid is injected into the pillar hole 19 that formed on the center of the handle 14 from its top portion to form the oil chamber 20. In the riveter, the compressed air is guided into the lower portion of the pressure tank 16 by use of the trigger 15, wherein the compressed air pushes upward the piston 18 to shift the piston rod 12 inwardly into the oil chamber 20. Accordingly, the generated oil pressure forms the motive force to trigger the working of the riveting component of the main body 13 thereby accomplishing the riveting operation. When the trigger 15 stops input of the compressed air, the oil pressure generated by the oil chamber 20 will push backward the piston rod 12 to reach its original location.

The piston rod 12 that inserts into the location of the oil chamber 20 includes one end fixed to the center of the piston 18, wherein the rod body is penetrated into the pillar hole 33 of the position device 32, and the sealing ring 37 provides sealing function among these components. The assemblage between the position device 32 and the piston rod 12 are positioned in accordance with the centerline. When the piston 18 is moving for performing the riveting operation, the piston rod 12 will perform the reciprocating motion smoothly along the pillar hole 33 of the position device 32.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A center position device of a piston rod of a riveter, wherein said riveter comprises a handle, a pressure tank mounted below said handle, a first pillar hole formed on a center of said handle, said position device screwed to an outer end of said pillar hole, a piston having said piston rod penetrated from a second pillar hole of said position device to an oil chamber of said handle, wherein the improvement comprises:
a threaded hole formed on an opening of said first pillar hole of said center of said handle, a ring surface being formed at least on an outer end of said threaded hole with a diameter dimension larger than that of said threaded hole, said position device being screwed onto a center of said threaded hole, said position device comprising said second pillar hole formed on its center, an outer thread, an ring trench, a position ring, and an outer ring plate mounted on an outer ring thereof, said outer thread being disposed to cooperate with said threaded hole, a sealing ring being disposed in said ring trench, said position ring and said first pillar hole being ground in a homocentric manner, said outer ring plate being flatly disposed on an end surface of said handle by use of its inner ring surface, said outer thread of said position device being screwed into said threaded hole that forms on said opening of said handle, wherein said position device is precisely screwed and fixed to said threaded hole on said opening of said handle by mounting said position ring of said position device onto said ring surface of said opening of said handle, and said second pillar hole of said position device and said piston rod of said piston that mounts on a tank surface of said pressure tank are posited to align the same centerline.
